(19) United States
(12) Patent Application Publication
(10) Pub. No.: US 2015/0002873 A1
(43) Pub. Date: Jan. 1, 2015

(54) IMAGE FORMING APPARATUS, METHOD FOR CONTROLLING THE SAME, AND STORAGE MEDIUM

(71) Applicant: CANON KABUSHIKI KAISHA, Tokyo (JP)

(72) Inventor: Takekazu Kumagai, Kawasaki-shi (JP)

(21) Appl. No.: 14/311,635

(22) Filed: Jun. 23, 2014

(30) Foreign Application Priority Data
Jun. 26, 2013 (JP) 2013-133526
Dec. 17, 2013 (JP) 2013-260390

(51) Int. Cl. G06K 15/02

(52) U.S. Cl. CPC G06K 15/1852; G06K 15/181; G06K 15/183
USPC 358/1.13; 358/1.16

(57) ABSTRACT

An image forming apparatus includes a reading unit configured to read a first file from a storage device, a determination unit configured to determine whether a second file is attached to the read first file, a setting unit configured to make different print settings between the first file and the second file according to user's instruction, and a printing unit configured to print the first and second files based on the print setting made by the setting unit.

### BACKGROUND OF THE INVENTION

1. Field of the Invention

The present invention relates to an image forming apparatus that prints files including an attached file by a printing unit.

2. Description of the Related Art

There has conventionally been known an image forming apparatus that has a direct printing function of printing a file stored in a storage device such as a removable medium without using any personal computer (PC). In the image forming apparatus having such a direct printing function, for example, a portable document format (PDF) file can be printed.

An attachment file may be used and added to the PDF file. The attachment file of the PDF can be attached as, for example, a note or a reference material. As an apparatus for printing a PDF file to which such a file has been attached, there is known an image forming apparatus discussed in Japanese Patent Application Laid-Open No. 2008-54110.

### SUMMARY OF THE INVENTION

The present invention is directed to a unit that enables a user to easily make print setting for printing of an attached file.

According to an aspect of the present invention, an image forming apparatus includes a reading unit configured to read a PDF file from a storage device, a determination unit configured to determine whether an attachment file is added to the PDF file read by the reading unit, a setting unit configured to make different print settings between the PDF file to which the attachment file is added as a result of the determination and the attachment file according to user's instruction, and a control unit configured to cause a printing unit to print the PDF file and the attached file based on the print setting made by the setting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration of a printing apparatus.

FIG. 2 is a block diagram illustrating a software configuration of the printing apparatus.

FIG. 3 illustrates a screen example indicating a file list screen.

FIG. 4 illustrates an example of a print setting screen.

FIG. 5 illustrates an example of a printing order designation screen of an attached file.

FIG. 6 illustrates a screen image indicating a print setting screen of an attached file.

FIG. 7 is a flowchart illustrating extraction processing of an attached file.

FIG. 8 is a flowchart illustrating a printing process of a file including an attached file.

FIG. 9 is a diagram illustrating a file structure of a PDF file.

FIG. 10 is a diagram illustrating a structure of an object of a PDF body.

FIG. 11 is a diagram illustrating a structure of an object constituting an attached file.

FIG. 12 illustrates a print output example of a file including an attached file.

FIG. 13 is a diagram illustrating a system configuration according to a second exemplary embodiment.

FIG. 14 is a diagram illustrating a file list screen according to the second exemplary embodiment.

FIG. 15 is a diagram illustrating an attached file list screen according to the second exemplary embodiment.

FIG. 16 is a flowchart illustrating attached file extraction processing according to the second exemplary embodiment.

### DESCRIPTION OF THE EMBODIMENTS

Various exemplary embodiments, features, and aspects of the invention will be described in detail below with reference to the drawings.

Hereinafter, a first exemplary embodiment of the present invention will be described referring to the drawings.

First, terms used for describing the present exemplary embodiment will be described. In the present exemplary embodiment, “direct print” means a method for printing data to be printed by a printing apparatus without using any computer such as a PC. In the present exemplary embodiment, “PDF direct print” means a method for directly printing a PDF file defined according to International Organization for Standardization (ISO). In the present exemplary embodiment, as a PDF direct printing example, an example of directly printing a PDF file stored in a Universal Serial Bus (USB) memory by the printing apparatus will be described. The USB memory is an example of a removable medium. In place of the USB memory, a Secure Digital (SD) memory card, a memory stick, a smart medium, or a removable medium such as a memory card, namely, a PC card, can be used. Instead of a removable medium, a storage device such as a hard disk drive (HDD) or a solid state drive (SSD) included in the printing apparatus can be used.

The PDF file may be used with an attachment file added thereto. The attachment file of the PDF can be, for example, a file of a note or a reference material. In the present exemplary embodiment, an image forming apparatus for directly printing a PDF file to which such an attachment file has been added will be described.

Files of various file formats can be attached to the PDF file. For example, a Joint Photographic Experts Group (JPEG) file, a TagImage File Format (TIFF) file, or a DOC file can be attached to the PDF file. The attachment file may be used as, for example, a note or a reference material. In the present exemplary embodiment, a portion of the PDF file to which the attachment file has been added will be referred to as a PDF body. The attachment file can be attached to a specific page of the PDF body. Hereinafter, the PDF to which a file has been attached will be referred to as a PDF having an attached file.

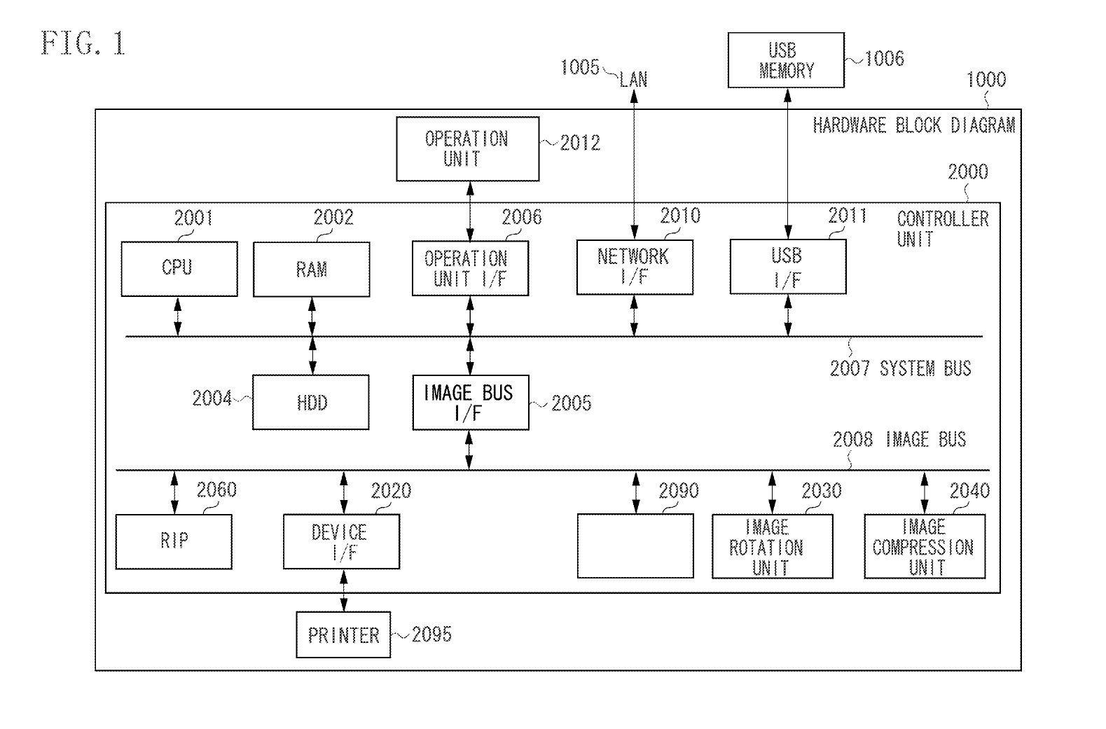

FIG. 1 is a block diagram illustrating a hardware configuration of a printing apparatus 1000 as an example of the image forming apparatus of the present exemplary embodiment. The printing apparatus 1000 includes a controller unit 2000. The controller unit 2000 is connected to a printer 2095 that is an image forming device. The controller unit 2000 is further connected to a local area network (LAN) 1005 to input/output image data or device information.

The controller unit 2000 includes a central processing unit (CPU) 2001. The CPU 2001 activates an operating system (OS) by a boot program stored in a HDD 2004. Then, the CPU 2001 executes various processes by executing application programs stored in the HDD 2004. A random access memory (RAM) 2002 is used as a work area of the CPU 2001. The RAM 2002 provides an image memory area for temporarily storing image data other than the work area. The HDD 2004 is a storage device that stores the image data, user information, and device setting information together with the application programs. In the present exemplary embodiment, for the HDD 2004, a hard disk drive is used. However, a SSD connectable by an interface of a Serial Advanced Technology Attachment (SATA) that is similar to the HDD can be used. The RAM 2002 is connected to the CPU 2001 via a system bus 2007. An operation unit interface (operation unit I/F) 2006, a network interface (internet I/F) 2010, and an image bus interface (image bus I/F) 2005 are connected to the CPU 2001. A USB I/F 2011 is connected to the system bus 2007. The USB I/F 2011 includes a USB connector. A file can be read from a USB memory 1006 connected to the USB connector and transferred to the CPU 2001. A file can be written in the USB memory 1006 from the CPU 2001. The operation unit I/F 2006, which is an interface with an operation unit 2012 including a touch panel and a plurality of hardware keys (or hard keys), outputs screen data to be displayed on the operation unit 2012 to the operation unit 2012. The operation unit I/F 2006 transmits information input at the operation unit 2012 by a user into the CPU 2001. The network I/F 2010 is connected to the LAN 1005, and exchanges information with each device on the LAN 1005 via the LAN 1005. The image bus I/F 2005 is a bus bridge for changing a data structure to connect the system bus 2007 to an image bus 2008 for transferring the image data at a high speed. The image bus 2008 includes a protocol control information (PCI) bus or Institute of Electrical and Electronics Engineers (IEEE) 1394. A raster image processor (RIP) 2060, a device I/F 2020, a printer image processing unit 2090, an image rotation unit 2030, and an image compression unit 2040 are arranged on the image bus 2008. The RIP 2060 is a processor that rasterizes a PDL code to obtain a bitmap image. The device I/F 2020, to which the printer 2095 for forming an image is connected, performs synchronous/asynchronous conversion of the image data. The printer image processing unit 2090 performs correction or resolution conversion of the printer 2095 on print output image data. The image rotation unit 2030 rotates the image data. The image compression unit 2040 compresses multivalued image data to be JPEG data and binary image data to be data of Joint Bi-level Image Experts Group (JBIG), Modified Modified Read (MMR), or Message Handling (MH), or decompresses the data.

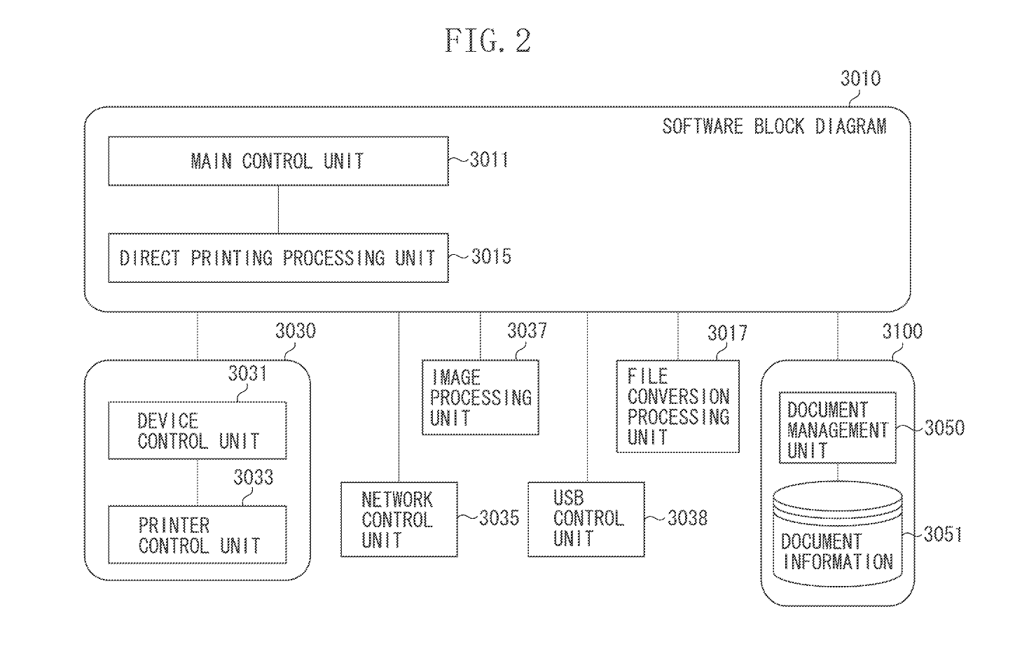

FIG. 2 is a software block diagram illustrating a main portion of a software configuration of an application program operating in the printing apparatus 1000.

The printing apparatus 1000 includes an operation unit application 3010, a device control unit 3030, a network control unit 3035, an image processing unit 3037, a USB control unit 3038, a file conversion processing unit 3017, and a data management unit 3100.

The operation unit 3010 is software for performing processing according to a user's operation of the operation unit 2012. The operation unit application 3010 includes a main control unit 3011, and a direct printing processing unit 3015. The main control unit 3011 presents screen display on the operation unit 2012, or basic inputting/outputting such as reception of a user's hard key operation or touch panel operation. The direct printing processing unit 3015 controls displaying, print setting, or printing of data (e.g., PDF file) stored in the built-in HDD 2004 or the USB memory 1006 that is a removal medium.

The data management unit 3100 is software for managing various data stored in the HDD 2004. The data management unit 3100 includes a document management unit 3050 and document information 3051. The document management unit 3050 performs creation, changing, deletion, or viewing processing of a document including a file such as image data stored in the HDD 2004, creation, deletion, or viewing of a folder for storing the document, changing of attribute information of the document or the folder, or temporary storage processing of the document. The file, the folder, and the attribute information are managed in the document information 3051.

The device control unit 3030 is software for controlling the printer 2095 by using the printer control unit 3033. The network control unit 3035 is a LAN driver that controls a LAN adaptor such as the network I/F 2010. The image processing unit 3037 is software for converting a full-color image into a black and white image, a single color image, or a two-color image, or enlarging/reducing the image. The image processing unit 3037 converts the image data into print data. The USB control unit 3038 is a USB driver that controls a USB device such as the USB memory 1006.

The file conversion processing unit 3017 is software for executing conversion from the PDF or Extensible Markup Language (XML) Paper Specification (XPS) into image data.

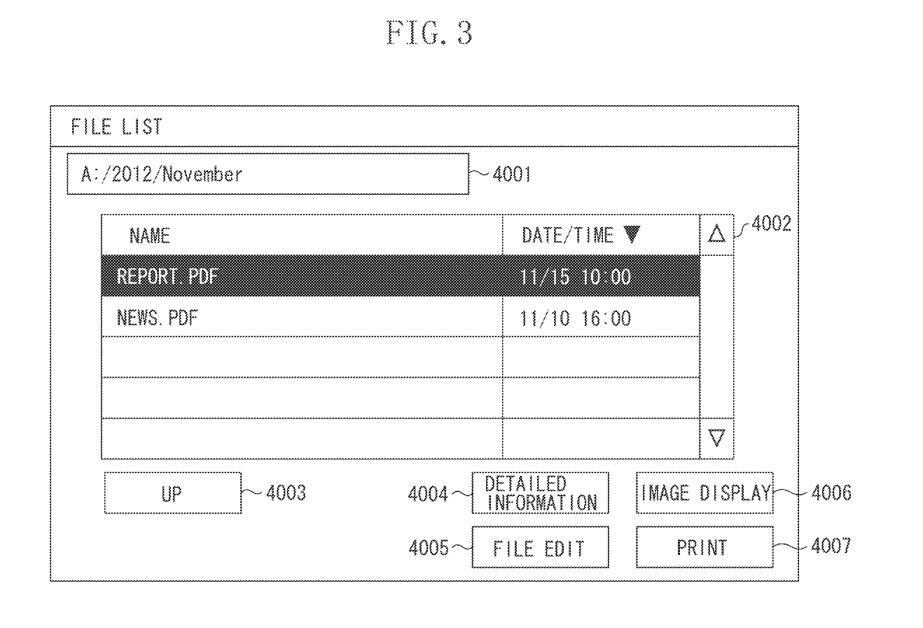

FIG. 3 illustrates an example of a “file list screen” for listing up files stored in the folder of the USB memory 1006. This screen is displayed on a touch panel display of the operation unit 2012 when the USB memory 1006 is connected to the USB connector of the USB I/F 2011.

In an area 4001, a name of a folder for storing a currently displayed file is displayed. In this example, a file list in a folder “/2012/November” of an A drive is displayed. In an area 4002, a file list in a folder is displayed. In this example, two files “REPORT. PDT” and “NEWS. PDF” are stored in the folder. In a date/time section, a file creation data/time is displayed.

On the screen illustrated in FIG. 3, when a file name of an unselected state is touched, one file can be selected. A file in a selected state is highlighted so that the user can identify the selected state. In the example illustrated in FIG. 3, the “REPORT.PDF” is color-highlighted, indicating that this file is in a selected state. On the other hand, on the screen illustrated in FIG. 3, the file name in the selected state can be changed to an unselected state by touching.

When an “up” button 4003 is touched on the screen illustrated in FIG. 3, processing for updating the contents of 4001 and 4002 to those of a folder of a layer higher than that of a currently displayed folder is performed. When the user touches the “up” button 4003 in the displayed state of the screen illustrated in FIG. 3, the folder name 4001 is changed from “A:/2012/November” to “A:/2012”. Then, in the file list display portion 4002, a folder “November” in “/2012” is displayed. When there is a file or a folder in addition to the “November” folder, the file or the folder is displayed together on the file list display portion 4002.

When a “detailed information” button 4004 is touched on the screen illustrated in FIG. 3, detailed information about a file in a selected state is displayed. The detailed information includes, for example, a file creator or a file data size. When a “file edit” button 4005 is touched, a file edit menu for the file in the selected state is displayed. In the file editing, a file name can be changed, or a file can be deleted. When an “image display” button 4006 is touched, a viewer for displaying contents of the currently selected file is displayed.

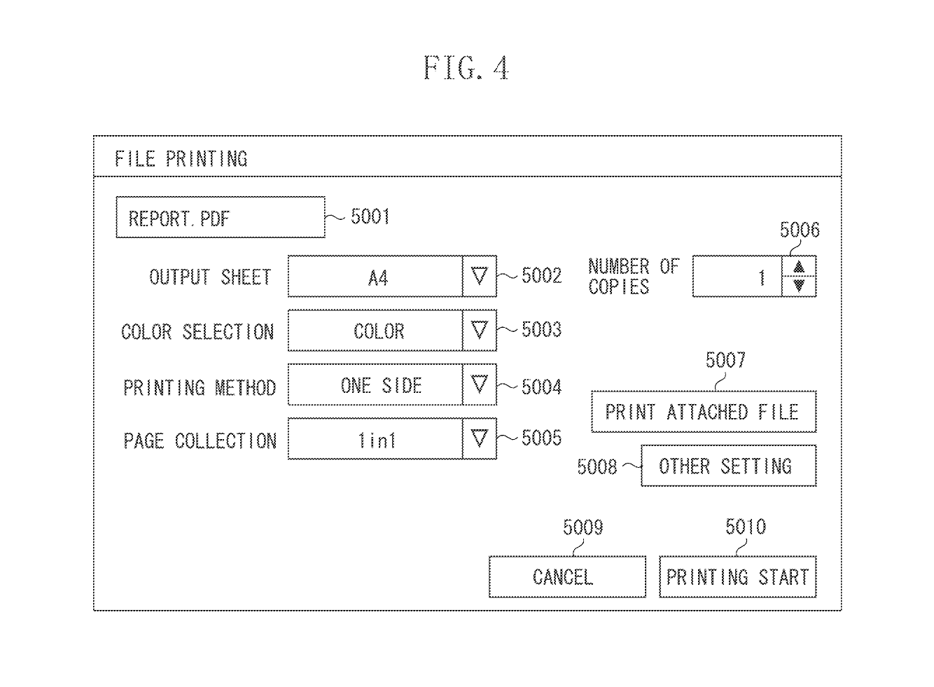

When a “print” button 4007 is touched on the screen illustrated in FIG. 3, a screen illustrated in FIG. 4, namely, a “print setting screen” for executing print setting of the file in the selected state is displayed.

Referring to FIG. 4, an example of a “file printing screen” will be described. In FIG. 4, when the “print” button 4007 is touched on the screen illustrated in FIG. 3, a file is displayed on the touch panel display of the operation unit 2012.

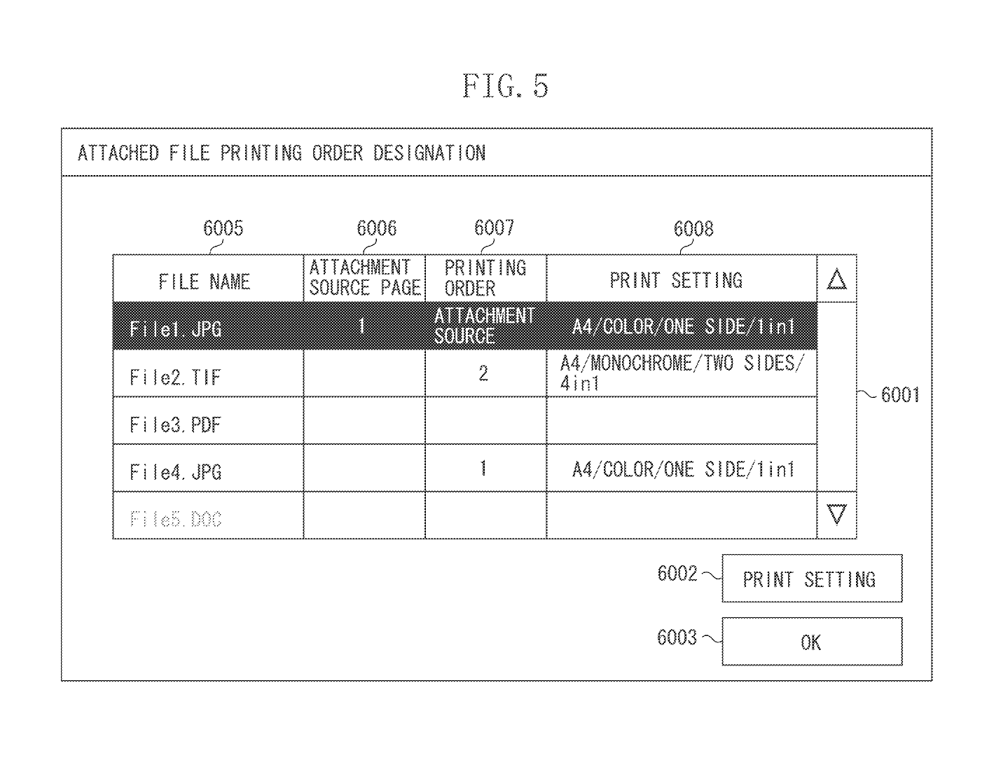

In an area 5001, a file name is displayed. Here, a file name of the printing target file selected in the file list display portion 4002 is displayed. “REPORT. PDF” is a printing target file. In an output sheet 5002, a size of recording paper to be used for print outputting can be selected according to user's instruction. Here, one of recording paper sizes registered in a paper cassette of the printing apparatus 1000 can be selected in a pull-down manner. In the example illustrated in FIG. 4, an A4 size is selected. In color selection 5003, color printing or monochrome printing of a print at the time of outputting can be selected according to user's instruction. In the example, color printing is selected. In a printing method 5004, one-side printing or two-side printing of a print at the time of outputting can be selected according to user's instruction. In the one-side printing, printing is executed only on a front surface of the recording paper. In the two-side printing, printing is executed on both of the front and rear surfaces of the recording paper. In the example, the one-side printing is selected. In page collection 5005, page collection can be selected according to user's instruction. The page collection is a printing method for arranging one or more surfaces of logical pages on the recording paper surface. In N in 1, N surfaces of logical pages are arranged on the recording paper surface, for example, in a manner that one surface of a logical page is arranged on the recording paper surface in 1 in 1, and two surfaces of logical pages are arranged on the recording paper surface in 2 in 1. The number of pages necessary for printing can be reduced by page collection. Accordingly, printing can be performed at reduced costs. However, the larger the number of surfaces (N) of logical pages, the smaller an area of the logical pages. Characters or graphs become thus smaller to be difficult to see. In the example, 1 in 1 is selected. In the number of copies 5006, the number of copies can be set. A numerical value can be changed by touching a numerical value display unit to operate hard keys (numerical keypad) having numerals engraved therein. One copy is increased by touching an upward triangle button displayed on the screen. One copy is decreased by touching a downward triangle button. In the example, one is set as the number of copies. When a “print attached file” button 5007 is touched, an “attached file printing order designation screen” illustrated in FIG. 5 is displayed. When no attached file is included in a selected file, if the button is touched, a message is displayed indicating non-inclusion of any attached file, and then the button is changed to a selection inhibited state. When an “other setting” button 5008 is touched, a screen for executing print setting not displayed in the “file printing screen” is displayed. For example, setting as to a vertical or horizontal direction of an image, or binding setting can be set. When a “cancel” button 5009 is touched, the screen is closed without reflecting a change on the screen, and the “file list screen” illustrated in FIG. 3 is displayed. When a “printing start” button 5010 is touched, print setting set on this screen and print setting set on the “other setting screen” are temporarily stored, and printing processing is started according to the designated print setting.

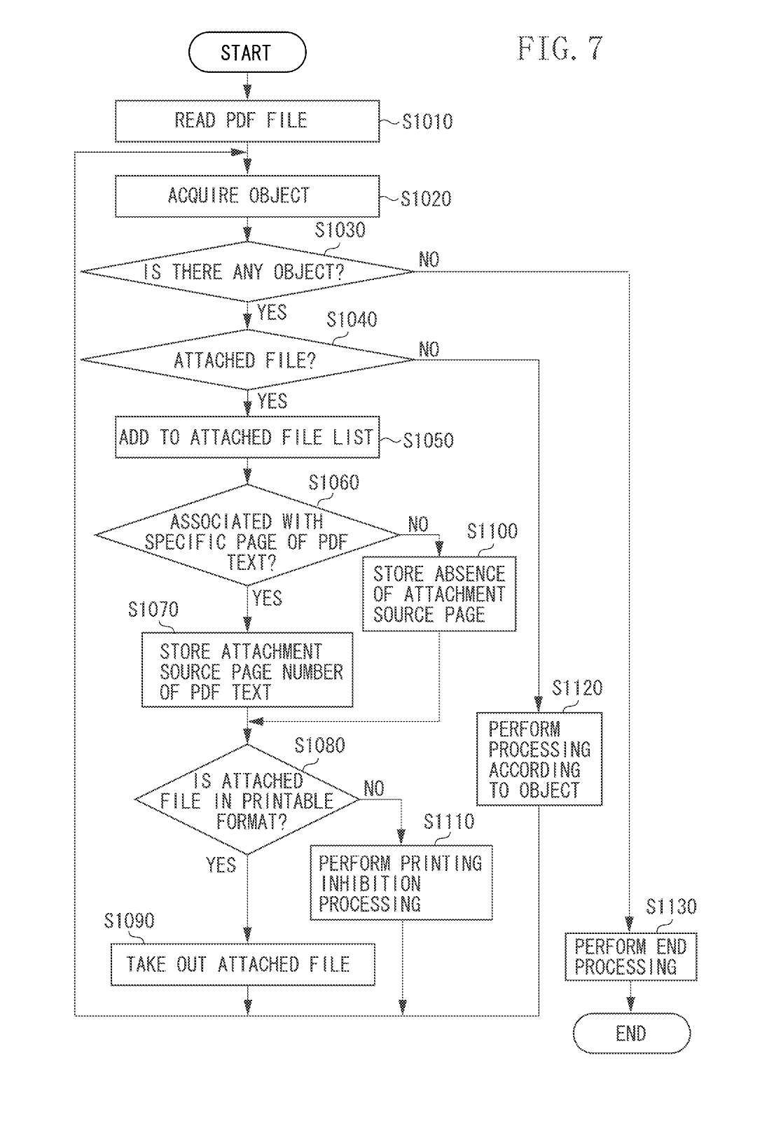

FIG. 5 illustrates an example of the “attached file printing order designation screen” as a list of attachment files attached to the selected file, on which a printing order of the attached files can be set. The selected file must be analyzed to draw the screen. File analysis processing will be described below referring to a flowchart illustrated in FIG. 7.

On the printing order designation screen illustrated in FIG. 5, in an area 6001, a list of attachment files attached to the selected file is displayed. In the attached file list 6001, for each attached file, a file name 6005, an attachment source page 6006 as a page number of a PDF file, a printing order 6007, and main print setting 6008 are displayed. In a section of the attachment source 6006, a page number of a PDF body is displayed only when the attached file is associated with a specific page of the PDF body. On the other hand, when the attached file is not associated with the specific page of the PDF body, the section of the attachment source page 6006 is blank. In the example illustrated in FIG. 5, “File. JPG” is attached to the first page of the PDF body. The sections of the attachment source page 6006 of other files “File 2. TIF”, “File 3. PDF”, “File 4. JPG”, and “File 5. DOC” are blank, and thus these files are not associated with the specific page of the PDF body.

In a section of the printing order 6007, a value of one of “attachment source”, “numerical value”, and “blank” is displayed. When the attached file is printed immediately after the page displayed in the attachment source page 6006, a value of the “attachment source” is displayed. In the example illustrated in FIG. 5, “File. JPG” is printed after an attachment source page of “REPORT. PDF” of an attachment source (immediately after first page).

When a specific numerical value is displayed in the section of the printing order 6007, a printing order when the attached files are printed in order after all the pages of the PDF file have been printed is displayed. Since the printing order is designated, numerical values are set in order from 1 for the number of attached files to be printed after the PDF body.

In the example illustrated in FIG. 5, the attached file “File. JPG” is printed after the first page of the PDF body “REPORT. PDF” has been printed. Then, after all the pages of the PDF body “REPORT. PDF” have been printed, the attached files “File 4. JPG” and “File 2. TIF” are printed in this order.

The blank state of the section of the printing order 6007 means that the attached file is not printed. In the example illustrated in FIG. 5, the sections of the printing order 6007 of the attached files “File 3. PDF” and “File 5. DOC” are blank, indicating that the attached files are not printed.

In the print setting 6008, main print setting of each attached file is displayed. In this example, the attached file “File 1. JPG” is printed based on setting of an output sheet A4, color printing, one-side printing, and 1 in 1. Also for the other files, the print setting is displayed based on their setting. The attached files “File 3. PDF” and “File 5. DOC” are not printed, and thus their sections are blank.

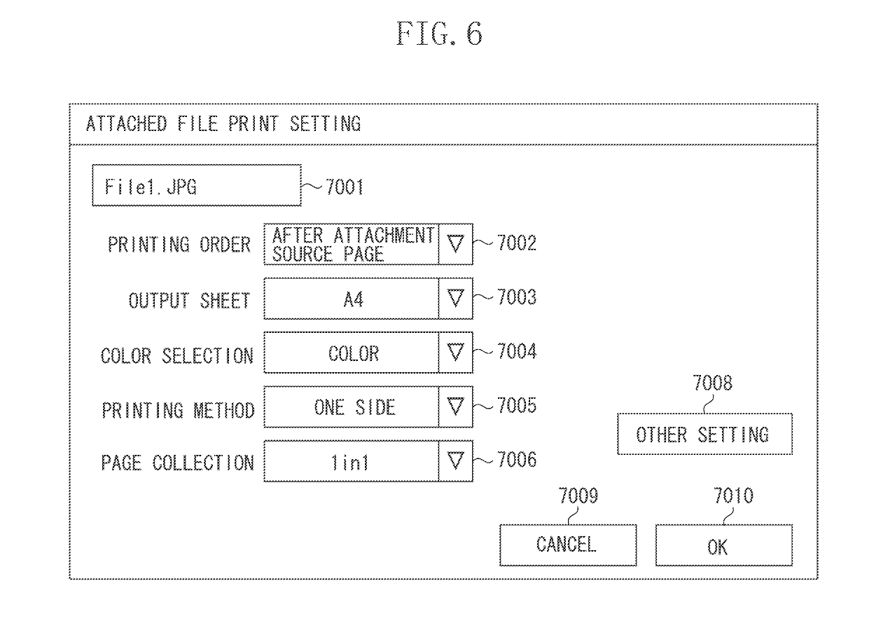

On the screen illustrated in FIG. 5, the attached file “File 1. JPG” is color-highlighted, indicating that this file is in a selected state. A character color of the attached file “File 5. DOC” is gray, indicating that this file form is not supported by the printing apparatus 1000. Data for displaying the attached file list 6001 is stored in an area secured in the RAM 2002. When the “print setting” button 6002 is touched, an “attached file print setting screen” illustrated in FIG. 6 is displayed. When an “OK” button 6003 is touched, this screen is closed.

FIG. 6 illustrates an example of an “attached file print setting screen” for designating print setting of each attached file. The screen illustrated in FIG. 6 is displayed on the touch panel display of the operation unit 2012 when the “print setting” button 6002 illustrated in FIG. 5 is touched.

On the screen illustrated in FIG. 6, in a file name 7001, a name of the attached file selected on the screen “attached file printing order designation” illustrated in FIG. 5 is displayed. On the screen illustrated in FIG. 6, print setting for the selected attached file can be designated.

In a printing order 7002, printing order can be designated and selected in a pull-down manner. In the present exemplary embodiment, one of “attachment source page”, “numerical value”, and “not print” can be selected. The “attachment source page” can be selected only when the attached file is associated with a specific page of the PDF body, in other words, only when a numerical value is designated in the section of the attachment source page 6006 illustrated in FIG. 5. When the “attachment source page” is selected, the attached file is printed immediately after a page of an attachment source page (immediately after printing of designated page).

The “numerical value” is a numerical value for designating what number of selected attachment files is printed after the printing of the attachment source file. When the “not print” is selected, the selected attachment file is not printed.

For an output sheet 7003, color selection 7004, a printing method 7005, and page collection 7006, choices similar to those of the output sheet 5002, the color selection 5003, the printing method 5004, and the page collection 5005 can be selected. These choices designate print setting for the selected attachment file, and the print setting can be designated independently of the print setting for the PDF body.

When an “other setting” button 7008 is touched, a screen similar to that when the “other setting” button 5008 is touched is displayed. When a “cancel” button 7009 is touched, the screen is closed without changing setting on the screen, and the processing returns to the “attached file printing order designation screen” illustrated in FIG. 5. When an “OK” button 7010 is touched, a setting change on the screen is temporarily stored, and the processing returns to the “attached file printing order designation screen” illustrated in FIG. 5. At this time, print setting or the like designated on the screen is displayed reflecting the setting on the “attached file printing order designation screen”.

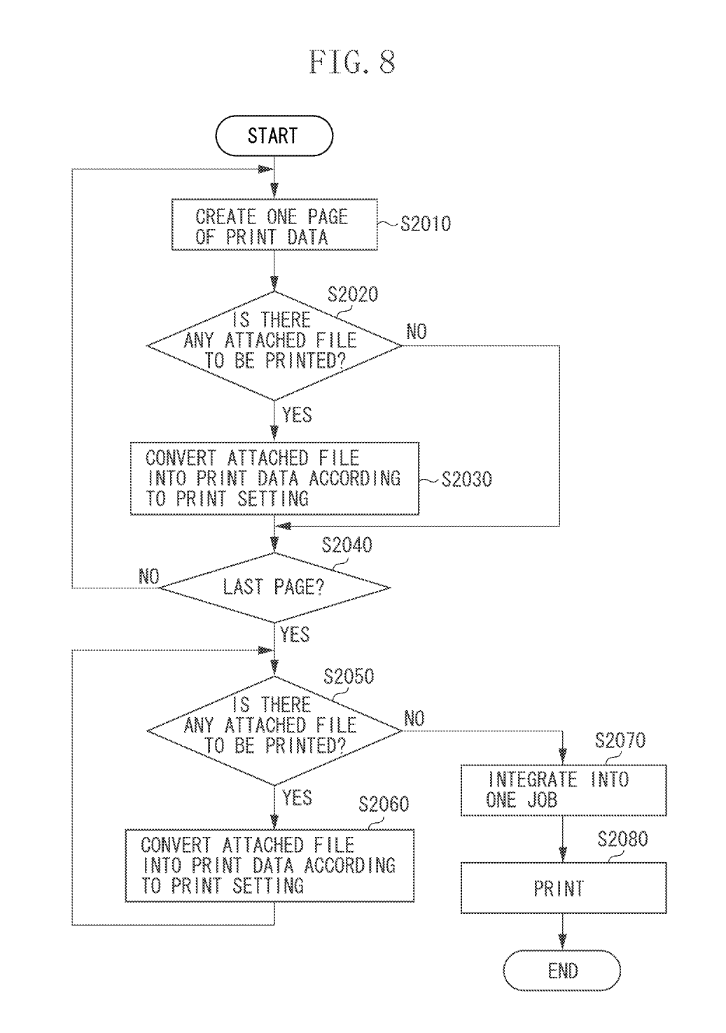

After the user has operated, for each attached file, the “attached file printing order designation screen” illustrated in FIG. 5 and the “attached file print setting screen” illustrated in FIG. 6 and desired print setting is completed, the processing returns to the “file printing screen” illustrated in FIG. 4. When the “printing start” button 5010 is touched on the “file printing screen” illustrated in FIG. 4, printing is started. Details on printing processing will be described below referring to a flowchart illustrated in FIG. 8.

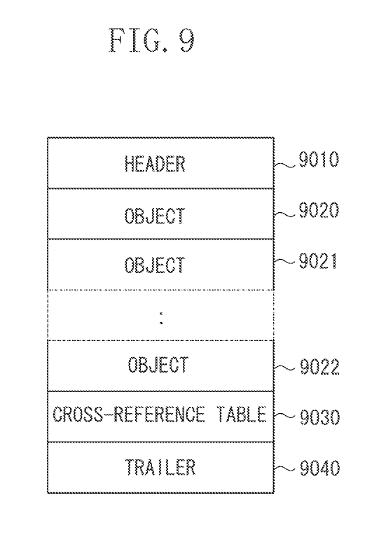

Referring to FIG. 9, a structure of the PDF file will be described. A header 9010 meaning that a file is a PDF file is disposed at the head of the file. A trailer 9040 is disposed at the tail of the file so that a cross reference table 9030 can be quickly found.

In the cross reference table 9030, a list of objects in the file is described, and the objects (9020, 9021, and 9022) in the file can be accessed by referring to the table. The object is a component such as a font, a page, a sampling image, or an embedded file stream constituting a document.

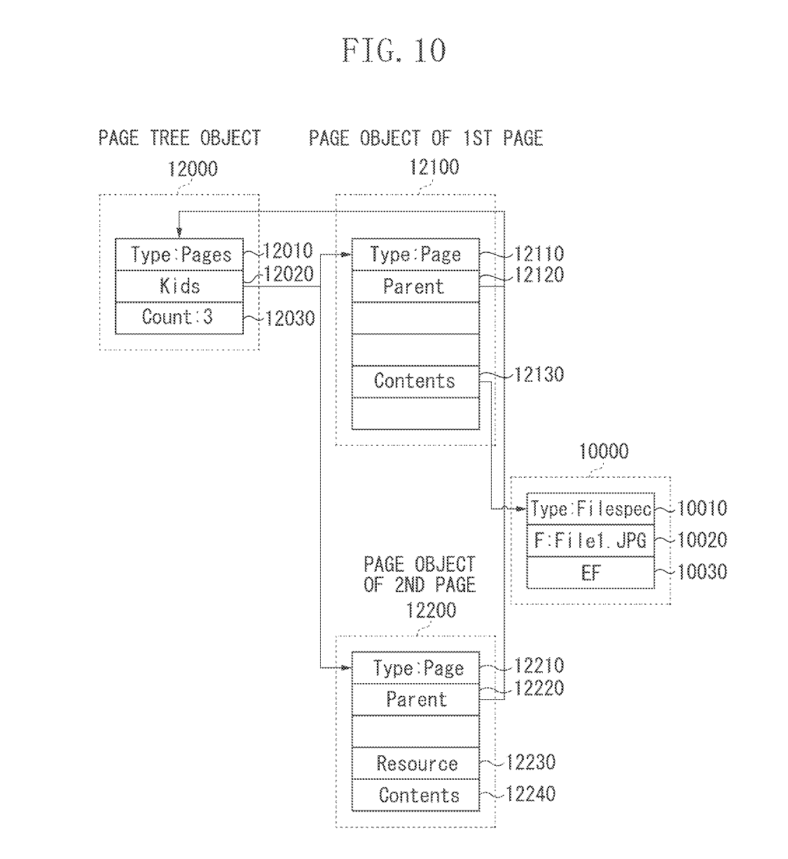

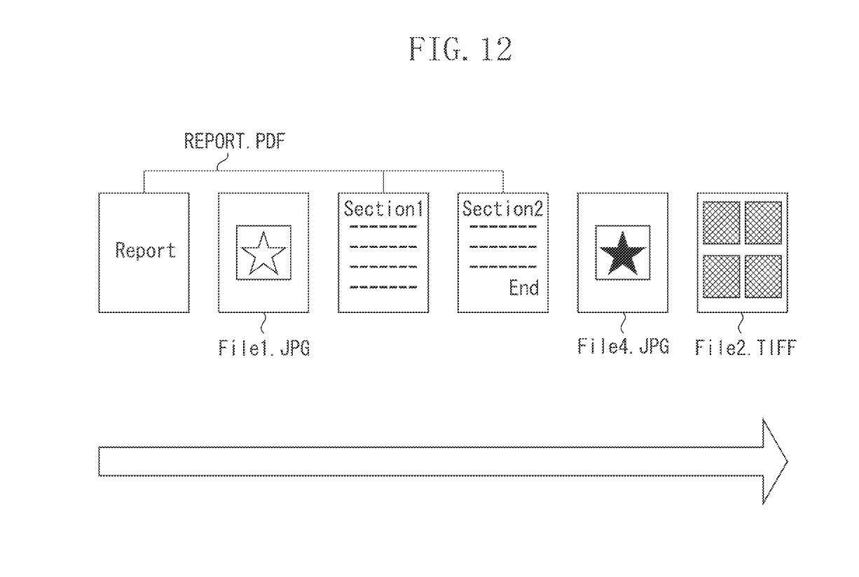

Next, referring to FIG. 12, an object for representing a PDF file to which an attachment file has been added will be described. A page tree object 12000 represents a page structure of REPORT. P. In 12010, “Type” is “Pages” to indicate 12000 is the page tree object. “Kids” is disposed as a second element of the page tree object. Here, indirect reference to pages objects is described in order of pages. The REPORT. PDF includes three pages. Accordingly, indirect reference to a page object of a first page (12100), a page object of a second page (12200), and a page object of a third page (not illustrated) is described. A last element is “Count” 12030 representing the number of pages. “3” is described. Next, the page object of the first page 12100 will be described. In 12110, “Type” is “Page” to indicate 12100 is the page tree object. In 12120, “Parent” for referring to a parent page tree is described as a second element. Here, indirect reference to 12000 is described because the parent page tree is 12000. A content stream 12130 is referred to on this page. Here, reference to a content arrangement or the like is described in order. Indirect reference to 10010 is described as one of contents because an attached file (File 1.jpg) illustrated in FIG. 10 is included.

Thus, by reference from the page object of the first page, attachment of the attachment file “File 1. jpg” to the first page can be determined. When there is no reference from the page object, it can be determined that no attachment source page is present.

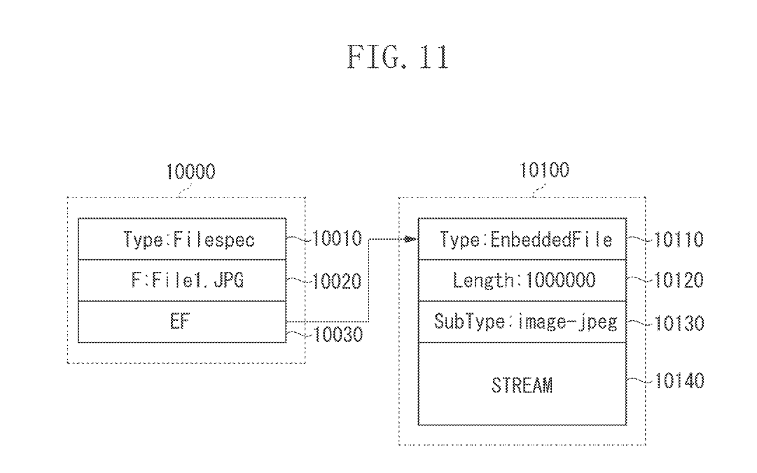

Next, referring to FIG. 11, an object representing an attached file will be described. An example representing the attached file “File 1. JPG” will be described. The attached file is represented by using two objects. First, the attached file is represented by referring to a file at a file designation object 10000 on the left side illustrated in FIG. 11. Type 10010 is “Filespec” indicating that the object is a file dictionary. F 10010 means that a file name is “File 1. JPG”. EF 10030 refers to an embedded file stream object 10100. The embedded file stream object is an object representing a file to be embedded. Type 10110 is “Embedded File” indicating that the object is an embedded file stream. Length 10120, which represents a stream length, indicates that the stream length is 1000000 bytes. SubType 10130, which is “image-jpeg”, indicates that the file is a JPEG file. Real data of the file is written in a stream 10140.

To display the “attached file printing order designation screen” illustrated in FIG. 5, a file structure must be analyzed. Referring to the flowchart illustrated in FIG. 7, analysis processing of the file structure will be described.

The processing of the flowchart illustrated in FIG. 7 is started when the user touches the “print attached file” button 5007 of the “file printing screen” illustrated in FIG. 4, which is displayed on the screen of the operation unit 2012. The CPU 2001 performs the processing of the flowchart by executing a program loaded from the HDD 2004 to the RAM 2002.

In step S1010, the CPU 2001 reads, to analyze a file structure, one of a selected state among the PDF files stored in the USB memory 1006 connected to the USB memory I/F 2011 to write the PDF file in the RAM 2002.

In step S1020, the CPU 2001 sequentially reads objects one by one from the cross reference table 9030 of the PDF file written in the RAM 2002.

In step S1030, when there is no more object to be processed, the CPU 2001 closes the file. The CPU 2001 executes memory releasing processing to end the flow.

In step S1040, the CPU 2001 determines whether the read object is an attached file. When Type of the object is Filespec as in the case of 10010, the CPU 2001 refers to Type of a reference destination object of an EF element. When the Type is Embedded File as in the case of 10110, the CPU 2001 determines that the object is an attached file (YES in step S1040). When it is not an attached file (NO in step S1040), the processing proceeds to step S1120, and processing according to the type of the object is performed. This processing is conventionally known processing.

In step S1050, the CPU 2001 reads a file name of the object determined to be an attached file in step S1040, secures an area for writing information of one file, and adds the read file name to the display area of the attached file list 6001. In the example of REPORT. PDF illustrated in FIG. 5, the attached files “File 1. JPG”, “File 2. TIF”, “File 3. PDF”, “File 4. PDF”, and “File 5. PDF” are sequentially read to be displayed in the display area of the attached file list 6001.

In step S1060, the CPU 2001 searches for a page object which refers to the object of the attached file to examine presence of a reference source. The processing proceeds to step S1070 when a reference source is present (YES in step S1060), and to step S1100 when it is not present (NO in step S1060).

In step S1070, the CPU 2001 writes a page number of the reference source in the area of the attachment source page 6006 of the attached file list 6001. In step S1100, the CPU 2001 writes blank data indicating that no reference source page is present in the area of the attachment source page 6006.

In step S1080, the CPU 2001 reads an extension of a file name 10020 of the attached file to determine whether the file is printable. In the present exemplary embodiment, the CPU 2001 determines that the files having extensions of “JPG”, “TIF”, and “PDF” are printable while others are not printable. The processing proceeds to step S1090 when printable (YES in step S1080), and to step S1110 when not printable (NO in step S1080).

In step S1090, the CPU 2001 writes a printable state in a printable data portion of the data storage area of the attached file list 6001. The CPU 2001 reads the stream 10140, and stores the data as temporary file information in document information 3051 by using the document management unit 3050.

In step S1110, the CPU 2001 writes an unprintable state in the printable data portion of the data storage area of the attached file list 6001.

The example displaying the attached file printing order designation screen has been described. By performing the processing procedure illustrated in FIG. 7, for example, the screen illustrated in FIG. 5 is displayed, thereby enabling the user to determine whether any attachment file has been added to the PDF body. The processing illustrated in FIG. 7 is started when the user touches the “print attached file” button 5007 on the screen illustrated in FIG. 4. However, the processing may be started after the USB memory 1006 has been connected to the USB I/F 2011.

Next, a procedure when the PDF file stored in the USB memory 1006 is printed will be described. A flowchart in FIG. 8 illustrates printing of attached files in a designated order. The CPU 2001 performs the processing of the flowchart by executing a program loaded from the HDD 2004 to the RAM 2002.

The processing of the flowchart illustrated in FIG. 8 is started when the “printing start” button 5010 on the file printing screen illustrated in FIG. 4 is pressed.

In step S2010, the CPU 2001 reads data of one page from the file stored in the RAM 2002, and coverts the data into a designated print format by using the file conversion processing unit 3017 and the image processing unit 3037. At this time, the CPU 2001 carries out the conversion according to the print setting designated on the “file printing screen” illustrated in FIG. 4. The CPU 2001 stores the print format data in the document information 3051 by using the document management unit 3050.

In step S2010, the CPU 2001 refers to an attachment source page portion of the data storage area of the attached file list 6001 to determine whether any attached file is present after a target page. When there is a value of “attachment source” set in the section of the printing order 6007 on the screen illustrated in FIG. 5, the determination is YES in step S2020.

The processing proceeds to step S2040 when there is no set value (NO in step S2020), and the processing proceeds to step S2030 when there is a set value (YES in step S2020). In step S2030, the CPU 2001 reads the attached file found in step S2020 from the document information 3051 by using the document management unit 3050. Then, the CPU 2001 coverts the read attached file into a print format by using the file conversion processing unit 3017 and the image processing unit 3037. At this time, the CPU 2001 carries out the conversion into the print format according to the print setting designated on the “attached file print setting screen” illustrated in FIG. 6. The CPU 2001 stores the print format data in the document information 3051 by using the document management unit 3050.

In step S2040, the CPU 2001 determines whether a last page has been processed. The processing proceeds to step S2050 when the last page has been processed (YES in step S2040), and proceeds to step S2010 when there is still a page to be processed (NO in step S2040). In steps S2050 and S2060, the CPU 2001 converts an attached file having no attachment source page, namely, an attached file associated with a specific page of the PDF body, into print data.

In step S2050, the CPU 2001 first sets a loop counter to 1 and determines whether there is any attached file to be printed. The processing proceeds to step S2060 when there is an attached file (YES in step S2050), and proceeds to step S2070 when not (NO in step S2050). The CPU 2001 carries out the determination whether there is any attached file matching with the loop counter, by referring to the printing order portion of the data storage area of the attached file list 6001. In step S2060, the CPU 2001 converts a file having a printing page portion matching with the loop counter into a print format to store it in the document information 3051. This processing is similar to that of step S2030. The counter loop is further incremented by 1.

In step S2070, the CPU 2001 integrates the print data stored in the document information 3051 in steps S2010, S2030, and S2060 into one print data so that they can be executed as one job.

In step S2080, the CPU 2001 executes the print job created in step S2070, forms an image with the printer 2095, and prints the image on a sheet. At this time, the PDF body is printed according to the received print setting illustrated in FIG. 5. When an attachment file is added, the attachment file is printed according to the received print setting illustrated in FIG. 6.

FIG. 12 illustrates a printing example according to the present exemplary embodiment. In the example illustrated in FIG. 12, the following four files are printed:
“REPORT. PDF” including three pages (PDF body);
attachment file “File 1. JPG” attached to a first page of the PDF body; and
attachment files “File 4. JPG” and “File 2. TIF” not associated with any specific page.
   In the example illustrated in FIG. 12, printing is performed according to the order set on the screen illustrated in FIG. 5.

In FIG. 12, the first page of the “REPORT. PDF” is printed, and then the attached file “File 1. JPG” is printed. Then, a second page and a third page of the “REPORT. PDF” are printed. When printing of all the pages of the “REPORT. PDF” is ended, subsequently, the first designated attached file “File 4. JPG” is printed. Lastly, the attached file “File 2. TIF” is printed. The attached file “File 2. TIF”, which includes eight pages, is printed on one recording paper because of print setting of two sides and 4 in 1. In FIG. 12, printing of only four logical faces is illustrated on a front surface. However, four logical faces are also printed on a rear surface.

The first exemplary embodiment has been described. According to the first exemplary embodiment, the printing order of the attached files and the print setting of the attached files can be designated for each file when the PDF file attached to the file is printed. As a result, usability can be improved for the user when the file including the attached file is directly printed.

Next, a second exemplary embodiment will be described with reference to the drawings.

The second exemplary embodiment will be described where a user directly prints a PDF file stored in a PC by using a web application operating on a web browser.

The PDF file includes a plurality of attachment files and the attachment files are printed together with a PDF body.

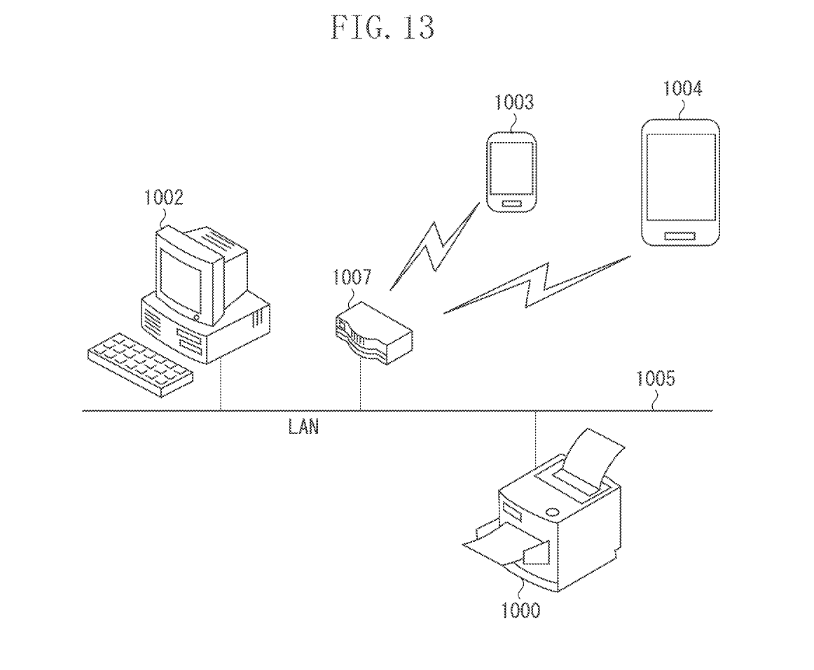

FIG. 13 is a diagram illustrating a system configuration including a printing apparatus according to the second exemplary embodiment. A printing apparatus 1000 is connected to a LAN 1005. A PC 1002 is connected to the LAN 1005 to be communicable with the printing apparatus 1000. A wireless LAN 1007 is connected to the LAN 1005. A configuration of the printing apparatus 1000 is similar to that of the first exemplary embodiment, and thus description thereof will be omitted.

A smartphone 1003 and a tablet terminal 1004 can communicate with the printing apparatus 1000 via a wireless LAN looter 10007.

Each of the PC 1002, the smartphone 1003, and the tablet terminal 1004 includes a web browser and is configured to display and operate a web page provided from a web server on a network.

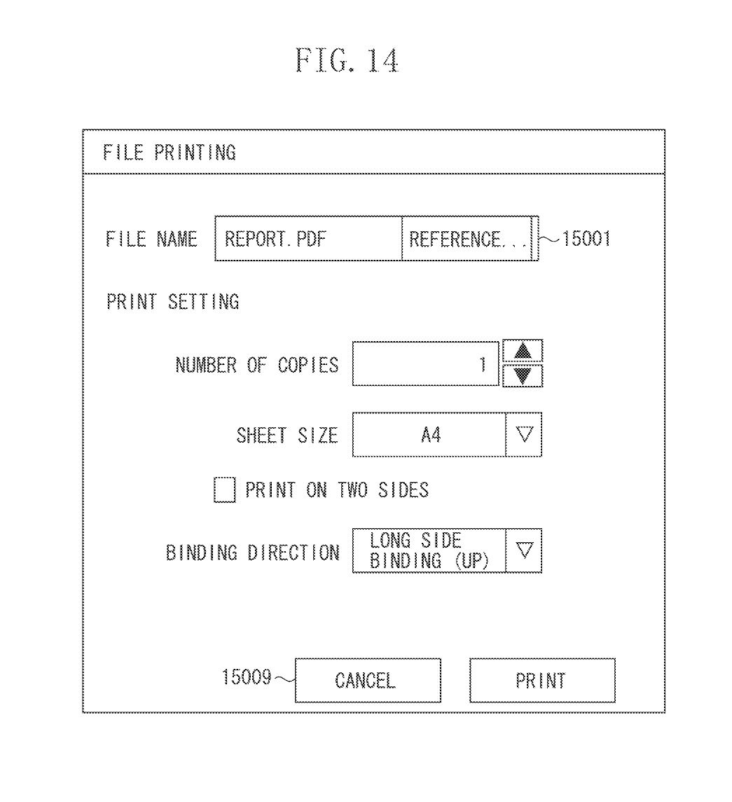

FIG. 14 illustrates an example of a file printing screen displayed on the web browser operating on the PC 1002. The file printing screen is displayed when the user accesses a Unified Resource Locator (URL) for executing the web page provided by the web browser to carry out direct printing. The screen is created by a web server unit (not illustrated) of the printing apparatus 1000 and returned to the PC 1002. At this time, the screen is created by using Hypertext Markup Language (HTML), and the screen or operation information of the screen is transmitted/received by using Hypertext Transfer Protocol (HTTP).

In FIG. 14, in a file name display portion 15001, a file name of a file to be printed is input. Characters can be directly input by using a keyboard. By operating a “reference” button, on a file selection screen provided from the web browser, a file can be selected and input from a list of files stored in a file system of the PC 1002. Here, a file name “REPORT. PDF” is a printing target. An output copy number designation unit can designate the number of copies to be printed and output. The number of copies to be printed can be directly input by using the keyboard. By operating an “upward triangle” button, the number of copies can be increased. By operating a “downward triangle” button, the number of copies can be decreased. Only a positive integer can be input. In the example, “one copy” is designated. An output sheet selection unit can select a size of recording paper to be printed and output. Here, one size can be selected among sizes of recording sheets stored in the printing apparatus. In the example, an A4 size is selected.

A two-side printing designation unit can select one-side printing or two-side printing for printing at the time of outputting. In the one-side printing, printing is performed only on a front surface of the recording paper. In the two-side printing, printing is performed on both of the front and rear surfaces of the recording paper. In the example, the one-side printing is selected.

A binding direction designation unit can designate a binding direction. As a binding direction, “long side biding (up)”, “long side binding (down)”, “short side binding (left)”, or “short side binding (right)” can be designated. In the example, the “long side biding (up)” is designated. After a “cancel” button 15009 has been operated, the operation of the cancel button is notified to a web UI operation unit 3016.

When a “print” button is operated, print setting set on this screen is transmitted to the web server unit of the printing apparatus 1000. At this time, the file designated in the file name display unit 15001 is also transmitted to the web UI operation unit.

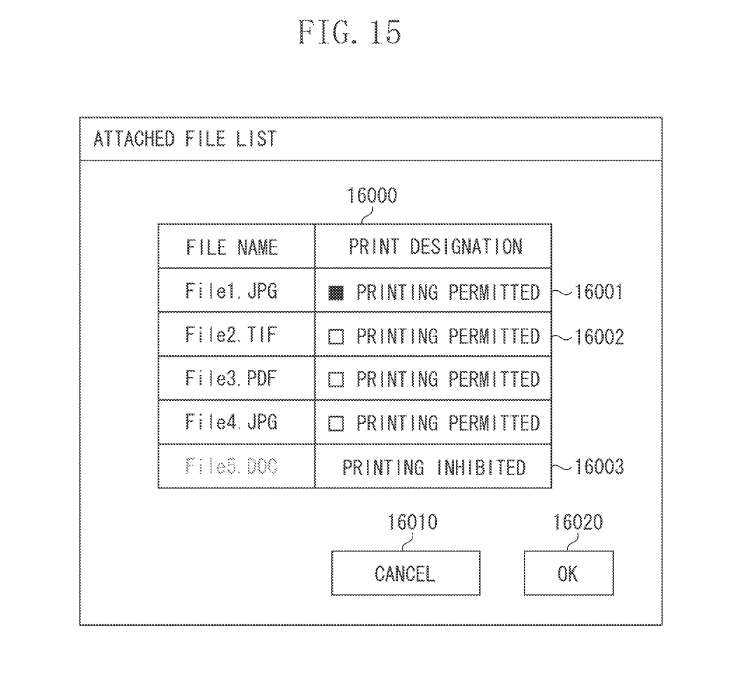

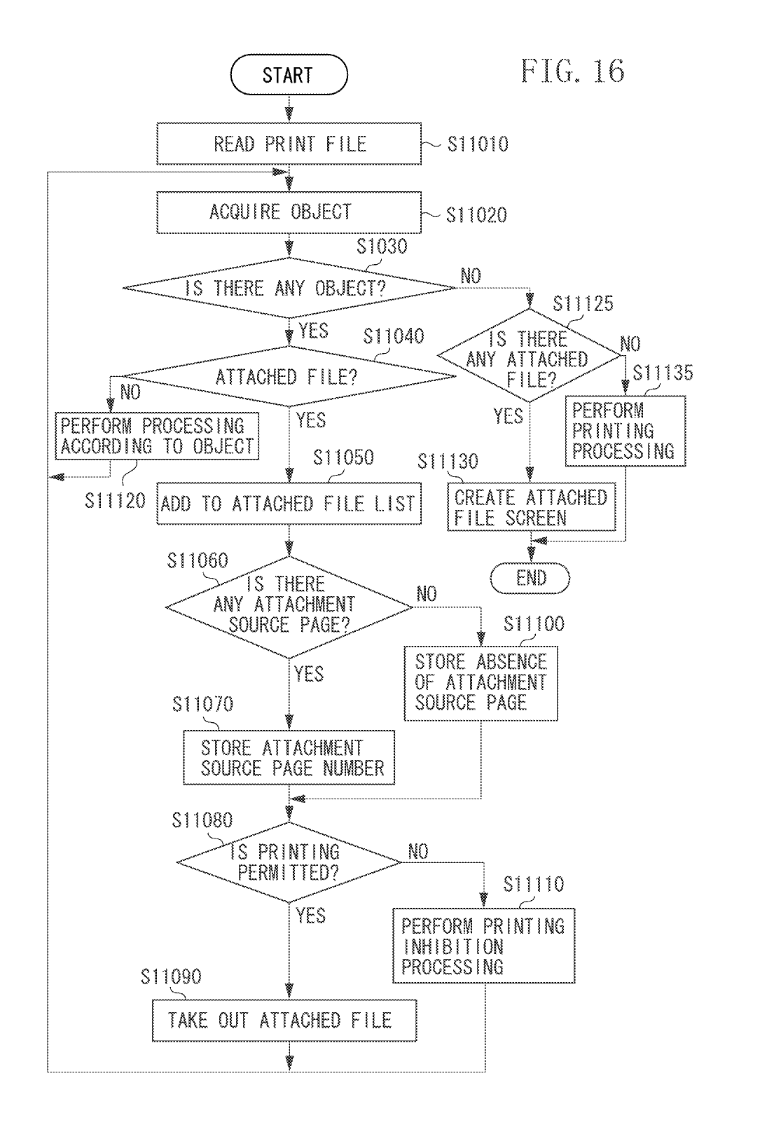

FIG. 15 illustrates an example of an attached file list screen for designating a list of attached files included in a selected file and indicating whether to print a file. To draw the screen, a file designated as a printing target must be analyzed. Analysis processing of the file will be described below referring to a flowchart illustrated in FIG. 16. In a portion 16000, the list of attached files included in the selected file is displayed. A file name or a print designation section is displayed for each attached file.

In the print designation section, whether the file is printable is displayed. When printable, a check box for designating whether to print the file is displayed.

A row 16001 includes a file of a file name “File 1. JPG”. “Printable” is displayed in the print designation section, and the check box is in a selected state. In this example, printing of the file “File 1. JPG” is designated. A row 16002 includes a file of a file name “File 2. TIF”, “printable” is displayed in the print designation section, and the check box is in an unselected state. In this example, the file “File 2. TIF” is not printed although it is printable. In a row 16003, a file name “File 5. DOC” is displayed in gray, and “unprintable” is displayed in the print designation section, thereby indicating that the file “File 5. DOC” is included but not printable.

By operating a “cancel” button 16010, a cancelling operation that has been executed is notified to the web server of the printing apparatus 1000. When an “OK” button 16020 is operated, a content designated on the screen is transmitted to the web server.

To display the “attached file list” screen illustrated in FIG. 15, a file structure must be analyzed. Analysis processing of the file structure will be described referring to the flowchart illustrated in FIG. 16. A CPU 2001 performs all steps of the flowchart by executing software of a direct printing processing unit 3015.

The processing is started when a user operates a “print” button 15010 of the “file printing screen” illustrated in FIG. 14, which is displayed on a web browser operated in the PC 1002. When the user operates the “print” button 15010 by the web browser, content designated on the screen and a substance of a file designated on the screen are transmitted to the printing apparatus 1000 via the LAN 1005. A unit 1001 receives the data transmitted via a network I/F 2010. This data reception processing is mainly executed by the web server of the printing apparatus.

In step S11010, the CPU 2001 stores a PDF file received by the printing apparatus 1000 from the PC 1001 and print setting designated on the “file printing” screen illustrated in FIG. 14 in a RAM 2002.

In step S11020, the CPU 2001 reads one object from a cross reference table 9030 of the PDF file stored in the RAM 2002.

In step S11030, when there is no more object to be further processed, the processing proceeds to step S11125. In step S11040, the CPU 2001 determines whether the read object is an attached file. When Type of the object is Filespec as in the case of 10010, the CPU 2001 refers to Type of a reference destination object of an EF element. When this is Embedded File as in the case of 10110, the CPU 2002 determines that the file is an attached file. When it is determined that the file is not an attached file (NO in step S11040), the processing proceeds to step S11120, and the CPU 2001 performs processing according to a type of the object. This processing is conventionally known, and thus description thereof will be omitted.

In step S11050, the CPU 2001 reads a file name “File 1. JPG” of an attached file, secures an area for writing information of one file in the data storage area of the attached file list 6001, and writes the file name in a file name portion.

In step S11060, the CPU 2001 searches for a page object referring to the object of the attached file to examine presence of a reference source. The processing proceeds to step S11070 when a reference source is present (YES in step S11060), and to step S11100 when not (NO in step S11060). In step S1170, the CPU 2001 writes a page number of the reference source in an attachment source page of the data storage area of the attached file list 6001. In step S11100, the CPU 2001 writes blank data indicating that no reference source page is present in the reference source page.

In step S11080, the CPU 2001 reads an extension of a file name 10020 of the attached file to determine whether the file is printable. In the present exemplary embodiment, the CPU 2001 determines that the files having extensions of “JPG”, “TIF”, and “PDF” are printable while others are not printable. The processing proceeds to step S11090 when printable (YES in step S11080), and to step S11110 when not (NO in step S11080).

In step S11090, the CPU 2001 writes a printable state in a printable data portion of the data storage area of the attached file list 6001. The CPU 2001 reads a stream 10140, and stores the data as temporary file information in document information 3051 by using the document management unit 3050.

In step S11110, the CPU 2001 writes an unprintable state in the printable data portion of the data storage area of the attached file list 6001.

In step S11125, for the file that is being analyzed, the CPU 2001 examines whether presence of an attached file has been determined in step S11040. The processing branches to step S11130 when presence of an attached file has been determined (YES in step S11125), and to step S11135 when not (NO in step S11125). In step S11130, the CPU 2001 creates an “attached file list” illustrated in FIG. 15 to transmit it to the PC 1002. In step S11135, the CPU 2001 prints the PDF file stored in the RAM 2002 according to setting of a direct print execution screen stored in the RAM 2002 and the attached file list screen. Then, the CPU 2002 returns a screen notifying the PC 1002 of a start of printing. In the present exemplary embodiment, as an example, the PDF file having the attached file stored in the USB memory 1006 has been described. For a PDF file having an attached file and stored in the HDD 2004, processing can be carried out by a similar method. In this case, the document management unit 3050 may be accessed in place of the USB control unit 3038.

The exemplary embodiment has been described by way of direct printing example of the PDF file. However, for example, the present invention can be applied to direct printing of Microsoft's OFFICE application file (docx or pptx).

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Laid-Open No. 2013-133526 filed Jun. 26, 2013, and No. 2013-260390 filed Dec. 17, 2013 which are hereby incorporated by reference herein in their entirety.

What is claimed is:

1. An image forming apparatus comprising:
a reading unit configured to read a first file from a storage device;
a determination unit configured to determine whether a second file is attached to the read first file;
a setting unit configured to make different print settings between the first file and the second file according to user's instruction; and
a printing unit configured to print the first and second files based on the print setting made by the setting unit.

2. The image forming apparatus according to claim 1, wherein the storage device is a removable medium.

3. The image forming apparatus according to claim 1, wherein the first file is a PDF file.

4. The image forming apparatus according to claim 1, wherein the storage device is provided in the image forming apparatus.

5. The image forming apparatus according to claim 1, wherein the determination unit analyzes an object included in the first file, and executes the determination based on a result of the analysis.

6. The image forming apparatus according to claim 1, wherein the print setting includes one of sheet size setting, color setting, one-side or two-side setting, and page collection setting.

7. The image forming apparatus according to claim 1, wherein the determination unit further determines whether the second file is printable by the printing unit.

8. The image forming apparatus according to claim 1, wherein after determination that the second file is attached to the first file, the determination unit determines an attachment source page of the first file to which the second file is attached.

9. The image forming apparatus according to claim 1, further comprising a display unit configured to display, when the determination unit determines that the second file is attached to the first file, information indicating the attachment of the attachment file.

10. An image forming apparatus comprising:
a reading unit configured to read a first file from a storage device;
a determination unit configured to determine whether a second file is attached to the read first file;
a setting unit configured to set a printing order of the first file and the second file according to user's instruction; and
a printing unit configured to print the first and second files based on the printing order set by the setting unit.

11. A method for controlling an image forming apparatus, comprising:
reading a first file from a storage device;
determining whether a second file is attached to the read first file;
making different print settings between the first file and the second file according to user's instruction; and
printing the first and second files based on the print settings which are made.

12. A method for controlling an image forming apparatus, comprising:
reading a first file from a storage device;
determining whether a second file is attached to the read first file;
setting a printing order of the first file and the second file according to user's instruction; and
printing the first and second files based on the set printing order which is made.

13. A non-transitory storage medium storing a program for causing an image forming apparatus to execute:
reading a first file from a storage device;
determining whether a second file is attached to the read first file;
making different print settings between the first file and the second file according to user's instruction; and
printing the first and second files based on the print setting which is made.

14. A non-transitory storage medium storing a program for causing an image forming apparatus to execute:
reading a first file from a storage device;
determining whether a second file is attached to the read first file;
setting a printing order of the first file and the second file according to user's instruction; and
printing the first and second files based on the set printing order.
